(19) United States
(12) Patent Application Publication
(10) Pub. No.: US 2023/0213158 A1
(43) Pub. Date: Jul. 6, 2023

(54) NATURAL LIGHTING DEVICE

(71) Applicant: NLS Co., Ltd., Gwangju-si (KR)

(72) Inventor: Seung Han KIM, Seongnam-si (KR)

(21) Appl. No.: 17/817,600

(22) Filed: Aug. 4, 2022

(30) Foreign Application Priority Data
Dec. 30, 2021 (KR) 10-2021-0193180

(51) Int. Cl. F21S 11/00; F21V 7/00; F21V 17/02

(52) U.S. Cl. CPC F21S 11/002; F21V 7/0033; F21V 17/02

(57) ABSTRACT

A natural lighting device is capable of controlling an angle of diffusion of sunlight reflected to a shaded area to form reflected light whose size and shape are suitable for a window of a household. The natural lighting device is installed in the vicinity of a building having a shaded area formed thereon to radiate sunlight toward a household located in the shaded area and includes a primary reflector configured to reflect sunlight incident thereon; and a secondary reflector configured to reflect the reflected light, which is reflected from the primary reflector, incident thereon, wherein the secondary reflector includes a secondary reflecting mirror having a curvature about an axis in a direction that intersects with the ground or an axis in a direction that is horizontal to the ground so that the reflected sunlight is not diffused in a horizontal direction or naturally diffused in a vertical direction.

### CROSS-REFERENCE TO RELATED APPLICATION

This application claims priority to and the benefit of Korean Patent Application No. 10-2021-0193180, filed on Dec. 30, 2021, the disclosure of which is incorporated herein by reference in its entirety.

### BACKGROUND

### 1. Field

The present disclosure relates to a natural lighting device, and more particularly, to a natural lighting device capable of controlling an angle of diffusion of sunlight reflected to a shaded area, thereby forming reflected light whose size and shape are suitable for the size of a window of a household.

### 2. Discussion of Related Art

Many modern people today live in high-rise buildings such as apartments and the like. In high-rise buildings such as apartments, the front (south-facing in the northern hemisphere) that faces the sun always receives light, but the rear (north-facing) of the building that is located opposite the sun is blocked from the sunlight due to a shadow of the building itself, and regarding another building located behind that building, even the front does not receive the sunlight due to the building located in front, and the right to light is infringed.

Therefore, in order to address the foregoing, efforts are continuously being made to secure sunlight by installing artificial structures such as natural lighting devices. Korean Patent Registration No. 10-1552776 discloses the related technologies.

The disclosure of this section is to provide background information relating to the present disclosure. Applicant does not admit that any information contained in this section constitutes prior art.

### SUMMARY

The present disclosure is directed to providing a natural lighting device which has low manufacturing costs, is easy to install and construct, and is capable of forming reflected sunlight having a lighting zone that corresponds to the size and shape of a window in a shaded area regardless of whether a distance to a radiation point is far or close.

One aspect of the present disclosure provides a natural lighting device which is installed in the vicinity of a building having a shaded area formed thereon to radiate sunlight toward a household located in the shaded area of the building, the natural lighting device including: a primary reflector configured to reflect sunlight incident thereon; and a secondary reflector configured to reflect the reflected light, which is reflected from the primary reflector, incident thereon, wherein the secondary reflector includes a secondary reflecting mirror having a curvature about an axis in a direction that intersects with the ground or an axis in a direction that is horizontal to the ground so that the reflected sunlight is not diffused in a horizontal direction or naturally diffused in a vertical direction.

The natural lighting device may further include a base which is supported by an installation surface and a connection frame which extends from the base to an upper side of the primary reflector and to which the secondary reflector is fixed, and the secondary reflector may further include a support plate which is fixed to the connection frame and to which the secondary reflecting mirror, which is configured to re-reflect primary reflected light reflected from the primary reflector, is fixed and a spacer which is disposed between the support plate and the secondary reflecting mirror and configured to cause any one of a central portion of the secondary reflecting mirror or an edge thereof to be spaced apart from the support plate.

The secondary reflecting mirror may be formed as a convex mirror which has the central portion protruding more than both side edges and is curved about the axis in the direction intersecting with the ground so that the reflected sunlight is diffused in the horizontal direction.

The spacer may be disposed at the central portion of the secondary reflecting mirror between the support plate and the secondary reflecting mirror and have the direction intersecting with the ground as a longitudinal direction, and may support the central portion of the secondary reflecting mirror so that the central portion protrudes more than both side edges.

A radius of curvature of the convex mirror may be 20 m or more and 30 m or less.

The secondary reflecting mirror may be formed as a concave mirror which has upper and lower edges protruding more than a central portion and is curved about the axis in the direction horizontal to the ground so that natural diffusion of the reflected sunlight in the up-down direction is offset.

The spacer may be formed at the upper edge and the lower edge of the secondary reflecting mirror between the support plate and the secondary reflecting mirror and have a direction parallel to the ground as a longitudinal direction and may support the upper and lower edges of the secondary reflecting mirror so that the upper and lower edges protrude more than the central portion.

A radius of curvature of the concave mirror may be 100 m or more and 130 m or less.

The natural lighting device may further include a tertiary reflector configured to reflect secondarily reflected sunlight, which is reflected from the secondary reflector, incident thereon toward the shaded area.

The tertiary reflector may be installed beside the secondary reflector while being spaced apart from the secondary reflector.

The tertiary reflector may include a tertiary reflecting mirror which is curved about the axis in the direction intersecting with the ground so that natural diffusion of the reflected sunlight in the left-right direction is offset.

### BRIEF DESCRIPTION OF THE DRAWINGS

The summary described above as well as the detailed description of embodiments of the present application which will be given below may be better understood when read in conjunction with the accompanying drawings. For the purpose of illustrating the present disclosure, the embodiments are shown in the drawings. However, it should be understood that the present application is not limited to the precise arrangements and instrumentalities shown.

FIG. 1 is a view illustrating a state in which a pixel-type natural lighting device that radiates sunlight where a shaded area is formed is installed.

FIG. 2 is a view illustrating the pixel-type natural lighting device.

FIG. 3A is a view illustrating sunlight radiated from the sun to the earth.

FIG. 3B is a view illustrating a state in which sunlight reflected using a flat quadrangular mirror is naturally diffused.

FIG. 4A is a view illustrating a situation in which sunlight is transmitted to a shaded area using the pixel-type natural lighting device.

FIG. 4B is a view illustrating a lighting zone radiated to a window in the shaded area using the pixel-type natural lighting device.

FIG. 5A is a view illustrating a state in which sunlight is transmitted to a window in a shaded area using the pixel-type natural lighting device when a separation distance between buildings is large.

FIG. 5B is a view illustrating a lighting zone radiated to the window in the shaded area in the case of FIG. 5A.

FIG. 6 is a view illustrating a state in which, when a distance between buildings is very small, reflected light is interfered with by a roof of one building when sunlight is reflected and transmitted to a window in a shaded area on the other building using the pixel-type natural lighting device.

FIGS. 7 and 8 are views illustrating a natural lighting device according to one embodiment of the present disclosure.

FIG. 9 is an exploded perspective view illustrating a secondary reflector of the natural lighting device according to one embodiment of the present disclosure.

FIG. 10 is a cross-sectional view of the secondary reflector of the natural lighting device according to one embodiment of the present disclosure.

FIG. 11 is a view illustrating reflected light that is transmitted to a window in a shaded area using the natural lighting device according to one embodiment of the present disclosure.

FIG. 12 is a view illustrating angles of diffusion of reflected light when a reflecting mirror is flat and concave.

FIG. 13 is a view illustrating a natural lighting device according to another embodiment of the present disclosure.

FIG. 14 is an exploded perspective view illustrating a secondary reflector of the natural lighting device according to another embodiment of the present disclosure.

FIG. 15 is a cross-sectional view of the secondary reflector of the natural lighting device according to another embodiment of the present disclosure.

FIG. 16 is a view illustrating reflected light that is transmitted to a window in a shaded area using the natural lighting device according to another embodiment of the present disclosure.

FIG. 17 is a view illustrating a natural lighting device according to still another embodiment of the present disclosure.

FIG. 18 is an exploded perspective view illustrating a tertiary reflector of the natural lighting device according to still another embodiment of the present disclosure.

FIG. 19 is a view illustrating reflected light that is transmitted to a window in a shaded area using the natural lighting device according to still another embodiment of the present disclosure.

### DETAILED DESCRIPTION OF EMBODIMENTS

Hereinafter, embodiments of the present disclosure are described with reference to the accompanying drawings below. In describing the embodiments, the same names and same reference numerals will be used for the same components, and further description thereof will be omitted.

In one example, to secure sunlight artificial structures such as natural lighting devices can be installed in high places such as the roof of a building.

Such a natural lighting device is a device designed to supply sunlight limitedly to a partial area of an indoor space or designed to be installed on the roof of a high-rise building to compensate for sunlight in a shaded area of the building that sunlight does not reach.

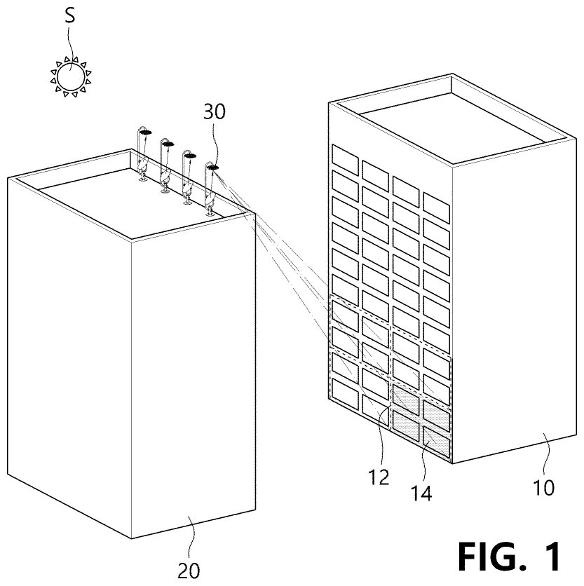

FIG. 1 is a view illustrating a state in which a natural lighting device 30 is installed on a building.

As illustrated in FIG. 1, the natural lighting device 30 may be installed on the roof or the like of a building 20 near a building 10 on which a shaded area 12 is formed and may reflect the radiated sunlight toward a window 14 of a household located in the shaded area 12 and cause the sunlight to be radiated to the window 14 of the household located in the shaded area 12.

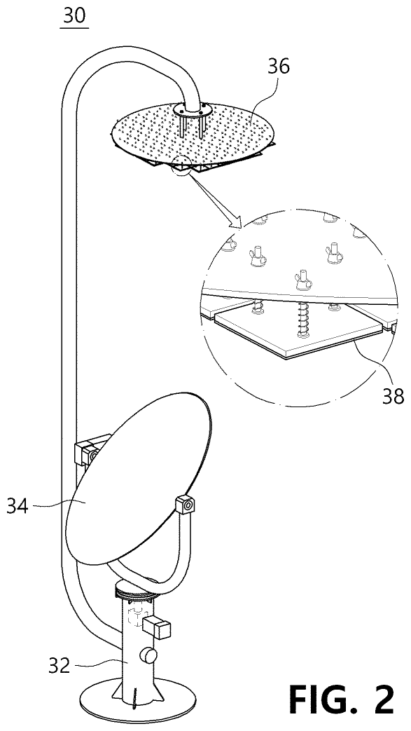

As illustrated in FIG. 2, the natural lighting device 30 includes a base 32 installed on an installation surface, a primary reflecting mirror 34 which is installed on the base 32 and whose angle is controlled to an optimal angle according to the position (altitude/azimuth) of the sun S in order to reflect sunlight, and a secondary reflecting mirror 36 configured to reflect the sunlight reflected from the primary reflecting mirror 34 to the window 14 of the household located in the shaded area 12.

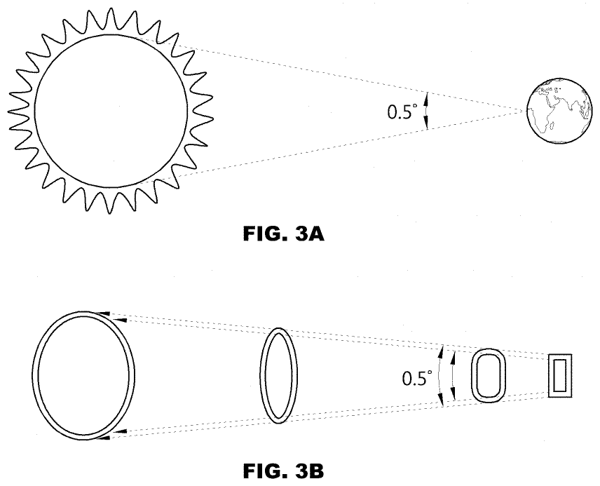

Meanwhile, as illustrated in FIG. 3A, the sunlight radiated from the sun to the earth forms an angle of about 0.5° due to a diameter of the sun, which is a circular light source, and a distance between the sun and the earth.

Therefore, as illustrated in FIG. 3B, even when the sunlight is reflected using a flat quadrangular mirror on earth, the reflected sunlight advances while being naturally diffused at an angle of about 0.5°, and the shape of a lighting zone formed by the sunlight reflected from the mirror is quadrangular right after being reflected but progressively becomes circular like the sun, which is the light source, with an increase in a distance from the mirror.

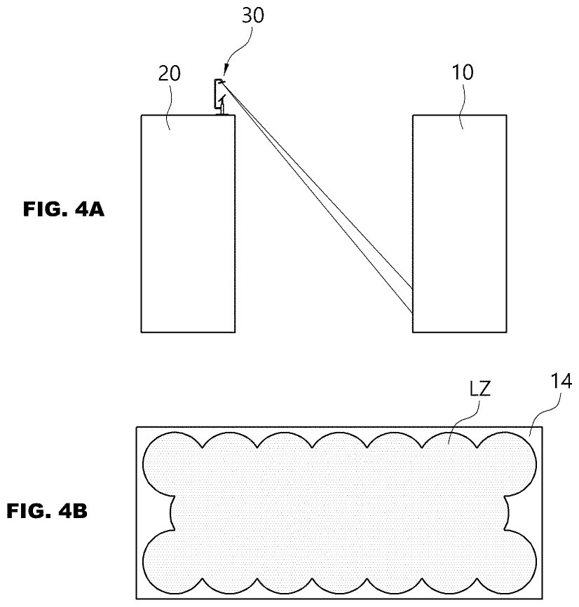

Due to such characteristics of reflected light, as illustrated in FIG. 4A, when the pixel-type natural lighting device 30 is applied to transmit sunlight from the nearby building 20 to the building 10 on which the shaded area is formed, in order to radiate the sunlight more uniformly to the building, as illustrated in FIG. 2, the secondary reflecting mirror 36, which is configured to reflect the sunlight reflected from the primary reflecting mirror 34 to the window 14 of the household located in the shaded area 12, is divided into a plurality of small pieces, and an angle of reflection of each small mirror (pixel) 38 is controlled to enable lighting design in which a lighting zone LZ is evenly distributed on the window 14 or appropriately focused as necessary as illustrated in FIG. 4B. In this way, a structure capable of addressing an infringement of the right to light can be provided.

However, in the structure discussed above, since an angle of each small mirror (pixel) 38 has to be controlled one by one, manufacturing costs increase and it is inconvenient and takes a long time to install and construct the structure.

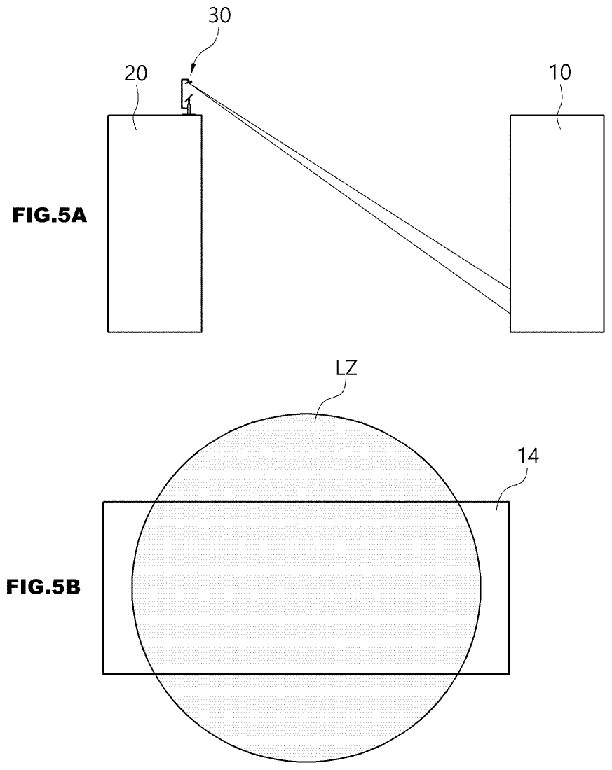

Also, as illustrated in FIG. 5A, when the building 20 on which the natural lighting device 30 is installed and the building 10 on which the shading area is formed are spaced apart at a large distance, e.g., about 200 m, since the lighting zone LZ itself due to a single small mirror 38 expands to a circular shape having a diameter of about 2 m, even when rays of sunlight transmitted from all the small mirrors 38 are accurately overlapped, the lighting zone LZ is formed larger than a vertical height of the window 14 as illustrated in FIG. 5B, which makes it difficult to efficiently use the reflected sunlight.

Also, when the distance between the buildings is extremely small as illustrated in

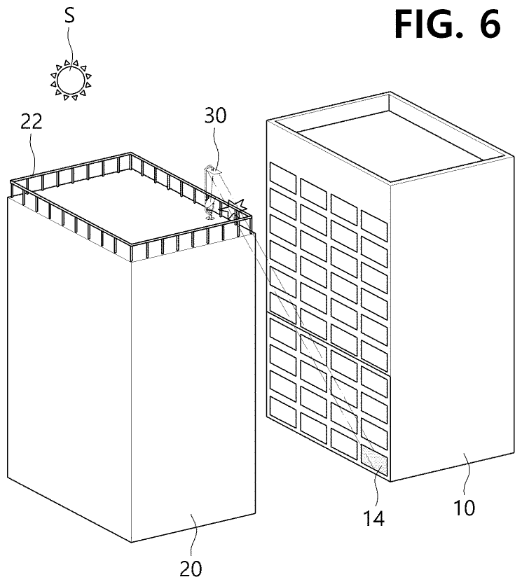

FIG. 6, since an angle from the roof of the nearby building toward the shaded area 12 at a lower floor of the building is extremely steep, the sunlight reflected from the secondary reflecting mirror 36 is interfered with by a railing 22 of the roof. Also, since an angle from the secondary reflecting mirror 36 toward the shaded area 12 at the lower floor is close to vertical, even when the sunlight is radiated toward the window 14 located in the shaded area 12, the sunlight does not reach deep into the indoor space, causing a decrease in satisfaction of a resident.

In the present disclosure, the x-axis and y-axis may indicate directions horizontal to the ground, and the z-axis may indicate a direction perpendicular to the ground.

Hereinafter, a natural lighting device 100 according to one embodiment of the present disclosure will be described.

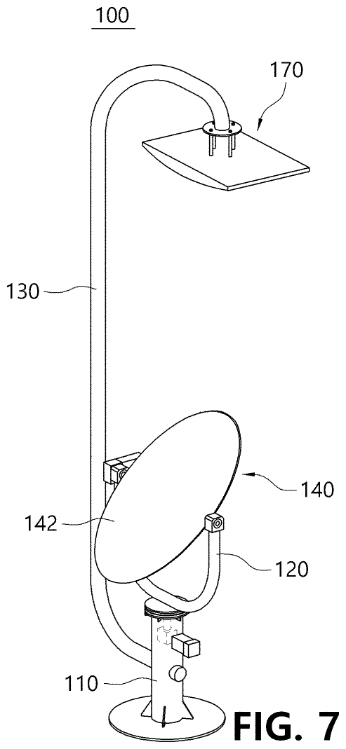

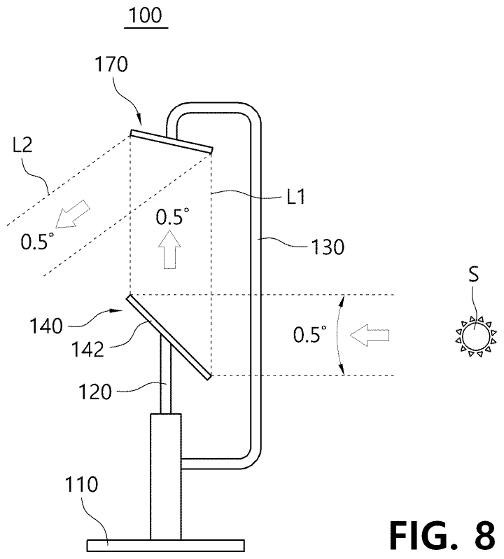

The natural lighting device 100 according to the present embodiment is installed in the vicinity of a building 10 having a shaded area 12 formed thereon to radiate sunlight toward a window 14 of a household located in the shaded area 12 of the building 10. As illustrated in FIGS. 7 and 8, the natural lighting device 100 may include a primary reflector 140 and a secondary reflector 170.

Also, the natural lighting device 100 may include a base 110 and a connection frame 130 which are configured to fix the primary reflector 140 and the secondary reflector 170 to an installation surface.

The base 110 may be installed on the installation surface on which the natural lighting device 100 is installed, that is, the roof or the like of a building 20 that is nearby the building 10 having the shaded area 12 formed thereon. Of course, the base 110 does not necessarily have to be installed on the roof of the building, and in some cases, the base 110 may be installed at a separate position at which sunlight can be secured and easily transmitted to the shaded area 12.

The primary reflector 140 may be mounted on the base 110.

As illustrated in FIGS. 7 and 8, the primary reflector 140 includes a primary reflecting mirror 142 configured to reflect sunlight incident thereon, and the sunlight can be reflected to the secondary reflector 170 by the primary reflecting mirror 142. The primary reflecting mirror 142 may be made of a reflecting mirror having a specular surface formed on a surface facing the sun.

The primary reflector 140 may be coupled to a support 120 which is rotatably coupled to an upper portion of the base installed on a floor surface of the roof of a building and may be installed on the roof or the like of a building that infringes on a right to light or a building that is adjacent to the building 10 having the shaded area 12 formed thereon.

The primary reflector 140 is coupled to the support 120 that is provided to be rotatable about the z-axis as the central axis with respect to the base 110 fixed to the floor surface.

The support 120 is provided to be rotatable about the z-axis or x-axis as the central axis with respect to the base 110 fixed to the floor surface. That is, a motor may be disposed in the base 110 and the support 120 to rotate the primary reflecting mirror 142 to correspond to the position (azimuth/altitude) of the sun so that the sunlight incident on the primary reflector 140 is reflected toward the secondary reflector 170 as efficiently as possible.

Meanwhile, the secondary reflector 170 may be provided to reflect a primary reflected light L1, which is reflected from the primary reflector 140, toward the window 14 located in the shaded area 12.

The secondary reflector 170 may be fixed by the connection frame 130 which extends from the base 110 to an upper side of the primary reflector 140.

The secondary reflector 170 is disposed above the primary reflecting mirror 142 and may be fixed to reflect the primary reflected light L1, which is reflected at a certain angle from the primary reflecting mirror 142, toward the window 14 in the shaded area.

Therefore, the sunlight incident on the primary reflector 140 may be reflected from the primary reflecting mirror 142 toward the secondary reflector 170, and the primary reflected light L1 reflected from the primary reflecting mirror 142 may be re-reflected from the secondary reflector 170 toward the window 14 in the shaded area.

Hereinafter, the sunlight reflected from the primary reflector 140 will be referred to as “primary reflected light L1,” and the sunlight reflected from the secondary reflector 170 will be referred to as “secondary reflected light L2.”

As described in the discussion in reference to FIG. 3A, natural sunlight in earth has an angle of natural diffusion of 0.5° in an advancing direction thereof. Accordingly, the primary reflected light L1 reflected from the primary reflector 140 also has an angle of diffusion of 0.5°, and the natural diffusion may occur in a horizontal direction and a vertical direction. Here, the horizontal direction may indicate a direction horizontal to the ground, and the vertical direction may indicate a direction perpendicular to the ground. Alternatively, in the present embodiment, the x-axis and the y-axis may indicate directions horizontal to the ground, and the z-axis may indicate a direction perpendicular to the ground.

However, the secondary reflector 170 may be provided to prevent the secondary reflected light L2, which is reflected from the secondary reflector 170, from being diffused in any one of the horizontal direction and the vertical direction or to allow the secondary reflected light L2 to be diffused at an angle larger than the angle of natural diffusion.

In the present embodiment, the secondary reflector 170 may be provided to allow the secondary reflected light L2 to be diffused at an angle larger than the angle of natural diffusion in the horizontal direction.

A case in which a distance from a position where the natural lighting device 100 is installed to a shaded area to be lighted is about 80 m, a width of the window 14 to be lighted that is located in the shaded area is about 4 m, and a width of a secondary reflecting mirror 172 of the secondary reflector 170 is about 0.5 m will be described as an example.

According to calculations by the applicant of the present disclosure, in order to diffuse and transmit sunlight so that the sunlight is radiated across the horizontal direction of the area to be lighted that has a width of 4 m and is 80 m apart from the mirror by using the mirror having a width of 0.5 m, the mirror may need to be formed as a convex mirror whose radius of curvature is about 28 m. When such a convex mirror is implemented as a mirror having a width of 0.5 m, the mirror may need to be processed so that the central portion of the mirror is convex by only 1 mm past the edge thereof.

Processing the mirror having such a curvature is not possible by using a mold which is a general production method, and ultra-precision processing may need to be performed through grinding or the like. However, the mirror produced in this way has a very high unit price and thus is difficult to apply in everyday life.

Meanwhile, mirrors are generally manufactured by mirror-finishing metal surfaces or by mirror-coating materials such as glass. In the case of glass mirrors which are the most efficient due to having high reflectivity, glass is extremely brittle and thus plastic deformation thereof is not possible, but elastic deformation that allows glass to be bent with a radius of curvature of about 28 m may be possible.

Therefore, in the present embodiment, the secondary reflecting mirror 172 of the secondary reflector 170 may be formed as a convex mirror which has the central portion protruding more than both side edges and is curved about the axis in the direction intersecting with the ground so that the reflected sunlight is diffused in the horizontal direction.

Since processing and producing the convex mirror having a radius of curvature of 28 m needs ultra-precision processing as described above, in the present embodiment, the secondary reflecting mirror 172 may be manufactured by being elastically deformed within a limit of elasticity of glass which is a material of the mirror. Although the radius of curvature of the secondary reflecting mirror 172 is described as being 28 m as an example in the present embodiment, the radius of curvature of the secondary reflecting mirror 172 may vary according to the size of the secondary reflecting mirror 172, the material constituting the secondary reflecting mirror 172, a distance between the secondary reflecting mirror 172 and the window 14 in the shaded area, the size of the window 14, or the like. The secondary reflecting mirror 172 may be made to have a radius of curvature that is 20 m or more and 30 m or less.

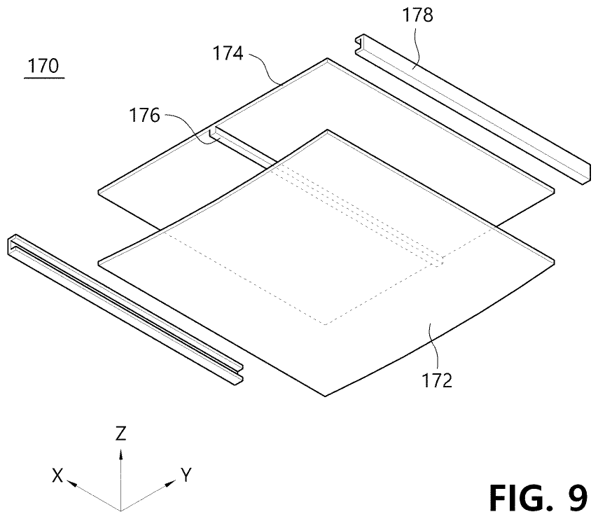

To this end, as illustrated in FIG. 9, the secondary reflector 170 may further include a support plate 174 and a spacer 176.

The support plate 174 may be fixed to the connection frame 130, and the secondary reflecting mirror 172 configured to reflect the primary reflected light L1 reflected from the primary reflector 140 may be supported by being fixed to the support plate 174. Here, the secondary reflecting mirror 172 may be bound to the support plate 174.

Also, the spacer 176 may be disposed between the support plate 174 and the secondary reflecting mirror 172 and may cause the central portion of the secondary reflecting mirror 172 to be spaced apart from the support plate 174.

That is, the secondary reflecting mirror 172 may be elastically deformed in the form of a convex mirror whose edge portions come into close contact with the support plate 174 and central portion protrudes and is convex due to the spacer 176.

Also, edge covers 178 may press and fix edges of the secondary reflecting mirror 172 and the support plate 174 and may fix the secondary reflecting mirror 172 and the support plate 174 in a state in which the central portion of the secondary reflecting mirror 172 is elastically deformed to be convex.

Here, the secondary reflecting mirror 172 may have the central portion protruding more than both side edges and be curved about the axis in the direction intersecting with the ground so that the reflected sunlight is diffused in the horizontal direction, and the spacer 176 may be disposed to have the direction intersecting with the ground as a longitudinal direction and may support the central portion of the secondary reflecting mirror 172 to protrude more than both side edges. Here, the direction of the ground may indicate a horizontal plane, and the direction intersecting with the ground may indicate a direction having a certain angle with respect to the horizontal plane.

The secondary reflecting mirror 172 may be curved in the horizontal direction and form a plane in the vertical direction.

Also, although the secondary reflecting mirror 172 is described as having a quadrangular shape as an example in the present embodiment, the present disclosure is not necessarily limited thereto.

Here, a length at which the central portion of the secondary reflecting mirror 172 protrudes past the edge portions thereof due to the spacer 176 may be about 1 mm when the width of the mirror is 0.5 m. Of course, the present disclosure is not limited thereto, and the length may also be less than 1 mm or more than 1 mm depending on the width of the mirror.

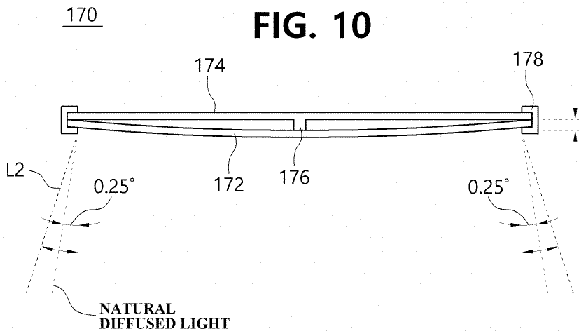

Therefore, as illustrated in FIG. 10, the secondary reflected light L2 reflected by the secondary reflecting mirror 172 may be diffused more widely than natural diffused light that is diffused at an angle of 0.5°.

Here, since the secondary reflecting mirror 172 is curved about the axis in the direction intersecting with the horizontal plane, the secondary reflected light L2 reflected by the secondary reflecting mirror 172 may be diffused identically as the natural diffused light in the up-down direction (vertical direction) and may be diffused more widely than the natural diffused light in the left-right direction (horizontal direction).

In the present embodiment, a case in which the secondary reflected light L2 reflected by the secondary reflecting mirror 172 is diffused 0.5° wider than the natural diffused light, which is diffused at 0.5°, and has an angle of diffusion of a total of 1.0° will be described as an example.

However, the present disclosure is not necessarily limited thereto, and the angle of diffusion of the secondary reflected light L2 reflected by the secondary reflecting mirror 172 may vary according to on-site conditions.

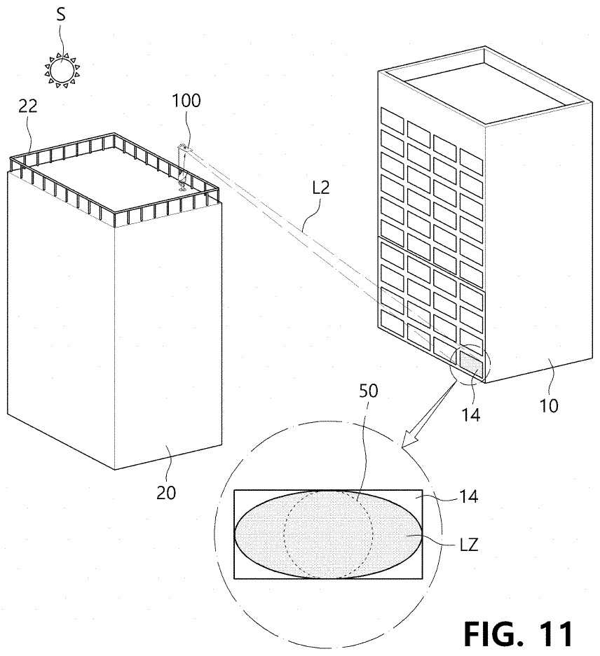

Therefore, as illustrated in FIG. 11, when the natural lighting device 100 is installed on the roof of the nearby building 20, due to the natural lighting device 100, a lighting zone LZ radiated to the window 14 of the building 10 having a shade formed thereon may be diffused like the natural diffused light in the up-down direction, but in the left-right direction, the lighting zone LZ wider than a lighting zone 50 of the natural diffused light may be formed and radiated across the window 14 which has a wide width in the left-right direction.

Meanwhile, when the pixel-type natural lighting device is installed far from the building having a shaded area formed thereon as illustrated in FIG. 5A, as illustrated in FIG. 5B, due to natural diffusion caused by the flat mirror, even when rays of sunlight diffused from all the pixel-type mirrors are accurately gathered to the same position, the lighting zone 50 formed on the window 14 may be formed wider than the length of the window in the up-down direction, and thus unnecessary waste of light may occur in the up-down direction of the window 14.

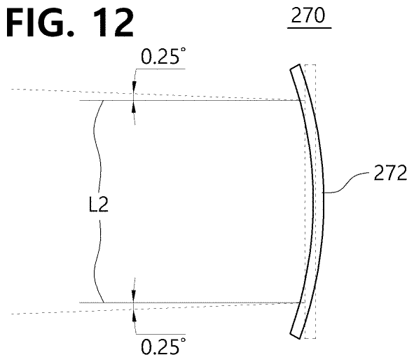

In order to prevent this, natural diffusion in the up-down direction of the sunlight reflected from the secondary reflector may need to be suppressed. For suppressing an angle of natural diffusion of the sunlight reflected from the mirror, there is a need to form a reflecting mirror 272 into a concave mirror as illustrated in FIG. 12.

In order to form sunlight whose angle of diffusion is formed at 0.5° due to natural diffusion into parallel sunlight at an angle of 0° that advances in a parallel manner without being diffused, opposite to the formation of the convex mirror as in the above-described embodiment, in order to further focus the light by about 0.25° at each of upper and low sides, a radius of curvature having an angle of 0.125° (=0.25°/2, sunlight is deflected at an angle that is two times the angle of the mirror) may need to be formed at each of upper and lower end points of the mirror. In order to transmit the sunlight of which natural diffusion is offset, the mirror may need to be formed as a concave mirror whose radius of curvature is about 115 m (when the width of the mirror is 0.5 m, a depth of a concave portion is about 0.3 mm), but as described above, processing and producing such a concave mirror may not be possible practically or commercially.

Therefore, the present embodiment proposes a structure to which a concave mirror formed by curving a flat mirror within a limit of elastic deformation is applied.

Hereinafter, a natural lighting device according to another embodiment of the present disclosure will be described.

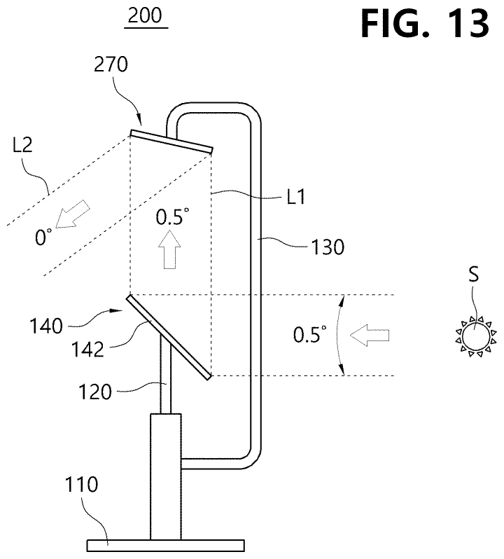

As illustrated in FIG. 13, a natural lighting device 200 according to the present embodiment may, similar to the natural lighting device 100 of the above-described embodiment, include a base 110, a connection frame 130, a primary reflector 140, and a secondary reflector 270.

Since the base 110, the connection frame 130, and the primary reflector 140 of the natural lighting device according to the present embodiment are identical to those in the above-described embodiment, detailed descriptions thereof will be omitted, and the same names and reference numerals will be assigned thereto.

Meanwhile, although the secondary reflector 170 of the above-described embodiment is formed as a convex mirror, the secondary reflector 270 of the present embodiment may be formed as a concave mirror.

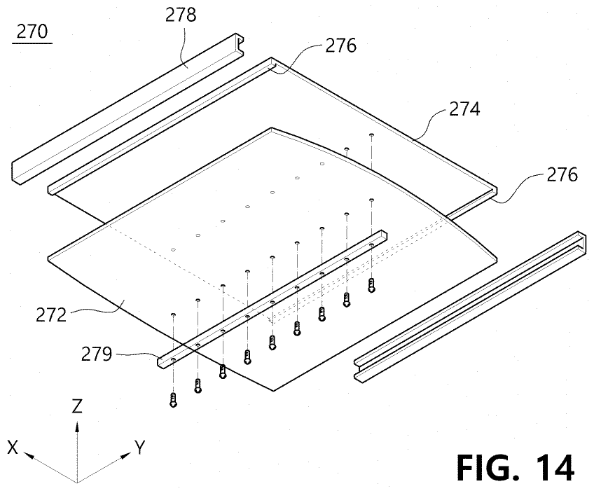

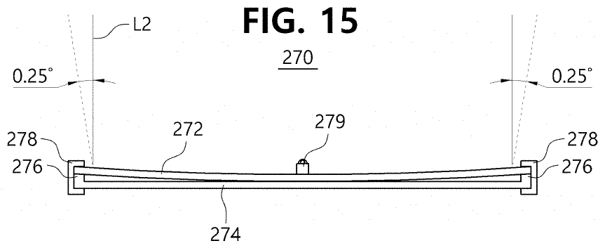

Also, as illustrated in FIGS. 14 and 15, the secondary reflector 270 may include the secondary reflecting mirror 272, a support plate 274, a spacer 276, a fixing edge, and a fixing bar 279.

The support plate 274 may be fixed to the connection frame 130, and the secondary reflecting mirror 272 configured to reflect the primary reflected light L1 reflected from the primary reflector 140 may be supported by being fixed to the support plate 274.

Also, the spacer 276 may be disposed between the support plate 274 and the secondary reflecting mirror 272 and may cause the edges of the secondary reflecting mirror 272 to be spaced apart from the support plate 274.

That is, the secondary reflecting mirror 272 may be elastically deformed in the form of a concave mirror whose central portion is fixed while in close contact with the support plate 274 and edge portions protrude due to the spacer 276.

Here, the secondary reflecting mirror 272 may be formed as a concave mirror which has upper and lower edges protruding more than a central portion and is curved about the axis in the direction horizontal to the ground so that natural diffusion of the reflected sunlight in the up-down direction is offset.

To this end, the spacer 276 may be formed on upper and lower side edges of the secondary reflecting mirror 272 between the support plate 274 and the secondary reflecting mirror 272 and have the direction parallel to the ground as a longitudinal direction, and may support the upper and lower side edges of the secondary reflecting mirror 272 so that the upper and lower side edges protrude more than the central portion.

Also, the central portion of the secondary reflecting mirror 272 may need to come into close contact with the support plate 274, and to this end, the fixing bar 279 may be coupled in a direction parallel to the spacer 276. The fixing bar 279 may be fastened to the support plate 274 from outside the secondary reflecting mirror 272 and cause the central portion of the secondary reflecting mirror 272 to come into close contact with the support plate 274.

Of course, in place of the fixing bar 279, other fixing elements such as a piece or a screw may be directly fastened to the support plate 274 from outside the secondary reflecting mirror 272.

Here, a length at which the edge portions of the secondary reflecting mirror 272 protrude past the central portion thereof due to the spacer 276 may be about 0.3 mm when the width of the mirror is 0.5 m. Of course, the present disclosure is not limited thereto, and the length may also be less than 0.3 mm or more than 0.3 mm depending on the width of the mirror.

Although the radius of curvature of the secondary reflecting mirror 272 is described as being 115 m as an example in the present embodiment, the radius of curvature of the secondary reflecting mirror 272 may vary according to the size of the secondary reflecting mirror 272, the material constituting the secondary reflecting mirror 272, a distance between the secondary reflecting mirror 272 and the window 14 in the shaded area, the size of the window 14, or the like. The secondary reflecting mirror 272 may be made to have a radius of curvature that is 100 m or more and 130 m or less.

Also, edge covers 278 may form edges of the secondary reflecting mirror 272 and the support plate 274.

Therefore, the secondary reflected light L2 reflected from the secondary reflecting mirror 272 may form parallel light of which natural diffusion at an angle of 0.5° is offset.

Here, since the secondary reflecting mirror 272 is curved about the axis in the direction horizontal to the horizontal plane, the secondary reflected light L2 reflected from the secondary reflecting mirror 272 may not be diffused in the up-down direction (vertical direction) and may be diffused identically as the natural diffused light in the left-right direction (horizontal direction).

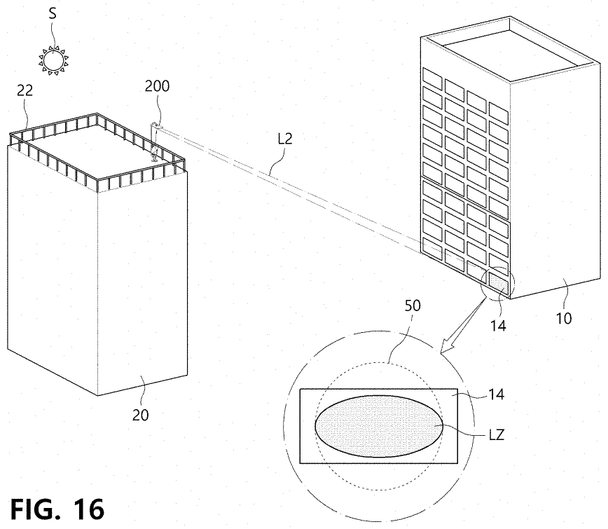

Therefore, as illustrated in FIG. 16, when the natural lighting device 200 is installed on the roof of the nearby building 20, due to the natural lighting device 200, a lighting zone radiated to the window 14 of the building 10 having a shade formed thereon may be formed as a lighting zone LZ that is narrower in the up-down direction than the lighting zone 50 formed by the pixel-type flat mirror of the natural lighting device shown in FIG. 5A, and thus the sunlight can be radiated without loss across the entire window 14 whose height is lower relative to its width.

Meanwhile, as described in the discussion of the related art, when the natural lighting device is installed too close to the building having a shaded area formed thereon, that is, when the building 20 that causes the shaded area 12 to be formed and the building 10 having the shaded area 12 formed thereon are disposed too close to each other, as described above with reference to FIG. 6, there is a problem that, since an angle from the roof of the nearby building 20 toward the shaded area at a lower floor of the building 10 is extremely steep, the sunlight reflected from the secondary reflector is interfered with by a railing 22 of the roof.

Hereinafter, a natural lighting device according to still another embodiment of the present disclosure will be described.

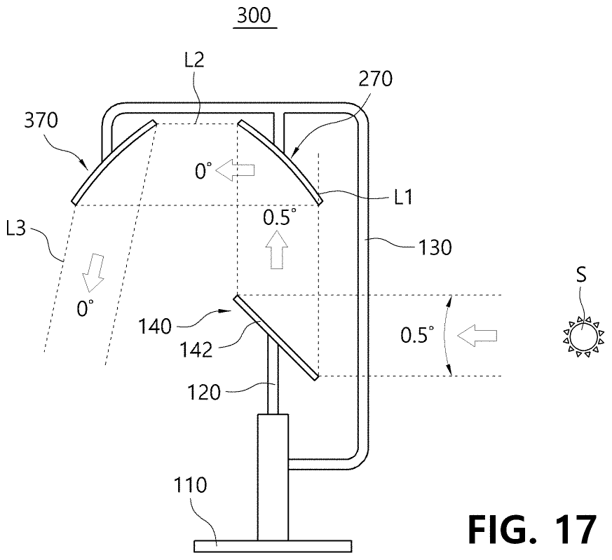

As illustrated in FIG. 17, a natural lighting device 300 according to the present embodiment may include a base 110, a connection frame 130, a primary reflector 140, a secondary reflector 270, and a tertiary reflector 370.

Here, since the base 110, the connection frame 130, the primary reflector 140, and the secondary reflector 270 are similar or substantially identical to the base 110, the connection frame 130, the primary reflector 140, and the secondary reflector 270 of the above-described embodiment, detailed descriptions thereof will be omitted.

However, while the secondary reflector 270 is provided to radiate the secondary reflected light toward the window 14 in the shaded area 12 in the above-described embodiment, the secondary reflector 270 of the present embodiment may be provided to reflect sunlight toward the tertiary reflector 370.

The tertiary reflector 370 may reflect sunlight incident thereon from the secondary reflector 270 and radiate the sunlight toward the window 14 in the shaded area 12.

The tertiary reflector 370 may be formed beside the secondary reflector 270 while being spaced apart therefrom and may be spaced apart from the secondary reflector 270 so that the tertiary reflector 370 is closer to the shaded area 12 than the secondary reflector 270.

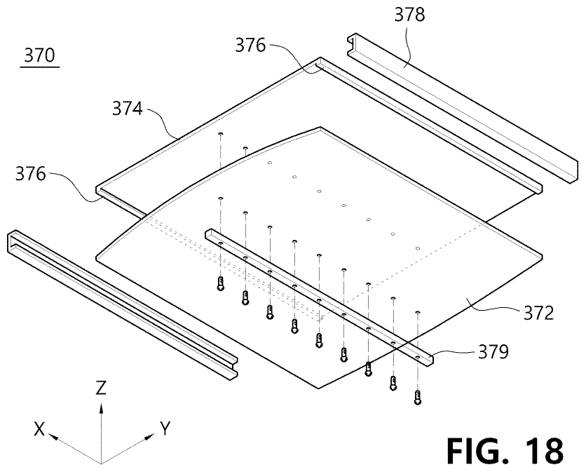

As illustrated in FIG. 18, the tertiary reflector 370 may include a tertiary reflecting mirror 372, a support plate 374, a spacer 376, edge covers 378, and a fixing bar 379.

Here, the tertiary reflecting mirror 372 may be formed as a concave mirror which has left and right edges protruding more than a central portion and is curved about the axis in the direction perpendicular to or intersecting with the ground so that natural diffusion of the reflected sunlight in the left-right direction is offset.

That is, the secondary reflecting mirror 272 is curved about the axis in the direction horizontal to the ground so that natural diffusion of the secondary reflected light L2 in the up-down direction is offset, and the tertiary reflecting mirror 372 may be curved about the axis in the direction perpendicular to the ground so that natural diffusion of tertiary reflected light L3 in the left-right direction is offset.

The support plate 374 may be fixed to the connection frame 130, and the tertiary reflecting mirror 372 configured to reflect the secondary reflected light L2 reflected from the secondary reflector 270 may be supported by being fixed to the support plate 374.

Also, the spacer 376 may be disposed between the support plate 374 and the tertiary reflecting mirror 372 and may cause the left and right edges of the tertiary reflecting mirror 372 to be spaced apart from the support plate 374.

The spacer 376 may be formed on left and right side edges of the tertiary reflecting mirror 372 between the support plate 374 and the tertiary reflecting mirror 372 and have the direction along the left and right side edges as a longitudinal direction and may support the left and right side edges of the tertiary reflecting mirror 372 so that the left and right side edges protrude more than the central portion.

Also, the central portion of the tertiary reflecting mirror 372 may need to come into close contact with the support plate 374, and to this end, the fixing bar 379 may be coupled in a direction parallel to the spacer 376. The fixing bar 379 may be fastened to the support plate 374 from outside the tertiary reflecting mirror 372 and cause the central portion of the tertiary reflecting mirror 372 to come into close contact with the support plate 374.

Of course, in place of the fixing bar 379, other fixing elements such as a piece or a screw may be directly fastened to the support plate 374 from outside the tertiary reflecting mirror 372.

Here, a length at which the edge portions of the tertiary reflecting mirror 372 protrude past the central portion thereof due to the spacer 376 may be about 0.3 mm when the width of the mirror is 0.5 m. Of course, the present disclosure is not limited thereto, and the length may also be less than 0.3 mm or more than 0.3 mm depending on the width of the mirror.

Also, edge covers 378 may form edges of the tertiary reflecting mirror 372 and the support plate 374.

Therefore, the tertiary reflected light L3 reflected from the tertiary reflecting mirror 372 may form parallel light of which natural diffusion at an angle of 0.5° is offset in the left-right direction. Here, since the secondary reflected light L2 incident on the tertiary reflecting mirror 372 has already been incident as parallel light, which is parallel in the up-down direction, from the secondary reflector 270, the tertiary reflected light L3 reflected from the tertiary reflecting mirror 372 may be parallel light that is not diffused in the up-down direction and left-right direction.

Of course, the positions of the secondary reflector 270 and the tertiary reflector 370 may be reversed. That is, the secondary reflector 270 may be provided to suppress natural diffusion in the left-right direction while the tertiary reflector 370 is provided to suppress natural diffusion in the up-down direction.

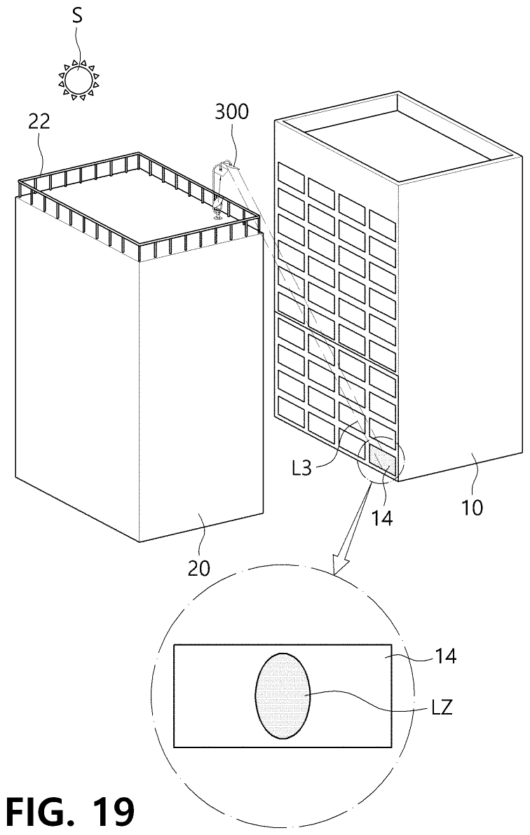

Therefore, since the tertiary reflecting mirror 372 is spaced apart from the secondary reflector 270 so that the tertiary reflecting mirror 372 is closer to the shaded area 12 than the secondary reflector 270, as illustrated in FIG. 19, the tertiary reflected light L3 reflected from the tertiary reflecting mirror 372 toward the window 14 in the shaded area 12 can be not interfered with by the railing 22 of the building.

Meanwhile, as described in the discussion of the related art, when the distance between the buildings is too small, since an angle at which the reflected light heads toward the shaded area 12 at a low floor becomes close to vertical, the sunlight may not reach deep into an indoor space even when uniformly radiated toward the window 14 located in the shaded area 12.

Therefore, since it is difficult to improve satisfaction of a resident by the pixel-type natural lighting device diffusing sunlight and uniformly radiating the sunlight toward the window 14, as illustrated in FIG. 19, parallel light of which natural diffusion is offset is focused and radiated toward the window 14 in the shaded area 12, and a louver and a blind (not illustrated) or a separate diffusion mirror (not illustrated) or the like that reflect the sunlight toward the window 14 in the shaded area 12 to diffuse the sunlight toward the inside of the building 10 are installed to effectively transmit the sunlight deep into the indoor space.

According to a natural lighting device of the present disclosure, there is no need to control each small mirror, which resembles a pixel, one by one, and even with a single secondary reflecting mirror, a lighting zone which is suitable for the size and shape of a window in a shaded area and does not cause loss of sunlight can be formed regardless of a distance to the shaded area. In this way, there is an effect of saving manufacturing costs and installation and construction costs.

Advantageous effects of the present disclosure are not limited to those mentioned above, and other unmentioned advantageous effects should become apparent to those of ordinary skill in the art from the claims below.

Embodiments according to the present disclosure have been described above, but the fact that the present disclosure can be embodied in specific forms other than the above-described embodiments without departing from the gist or scope of the present disclosure should be apparent to those of ordinary skill in the art. Therefore, the above-described embodiments should be considered illustrative instead of limiting, and accordingly, the present disclosure is not limited to the above description and may be changed within the scope of the attached claims and their equivalents.

What is claimed is:

1. A natural lighting device which is installed in the vicinity of a building having a shaded area formed thereon to radiate sunlight toward a household located in the shaded area of the building, the natural lighting device comprising:
a primary reflector configured to reflect sunlight incident thereon; and
a secondary reflector configured to reflect the reflected light, which is reflected from the primary reflector, incident thereon,
wherein the secondary reflector includes a secondary reflecting mirror having a curvature about an axis in a direction that intersects with the ground or an axis in a direction that is horizontal to the ground so that the reflected sunlight is not diffused in a horizontal direction or naturally diffused in a vertical direction.

2. The natural lighting device of claim 1, further comprising:
a base which is supported by an installation surface; and
a connection frame which extends from the base to an upper side of the primary reflector and to which the secondary reflector is fixed,
wherein the secondary reflector further includes a support plate which is fixed to the connection frame and to which the secondary reflecting mirror, which is configured to re-reflect primary reflected light reflected from the primary reflector, is fixed and a spacer which is disposed between the support plate and the secondary reflecting mirror and configured to cause any one of a central portion of the secondary reflecting mirror or an edge thereof to be spaced apart from the support plate.

3. The natural lighting device of claim 2, wherein the secondary reflecting mirror is formed as a convex mirror which has the central portion protruding more than both side edges and is curved about the axis in the direction intersecting with the ground so that the reflected sunlight is diffused in the horizontal direction.

4. The natural lighting device of claim 3, wherein the spacer is disposed at the central portion of the secondary reflecting mirror between the support plate and the secondary reflecting mirror and has the direction intersecting with the ground as a longitudinal direction and supports the central portion of the secondary reflecting mirror so that the central portion protrudes more than both side edges.

5. The natural lighting device of claim 4, wherein a radius of curvature of the convex mirror is 20 m or more and 30 m or less.

6. The natural lighting device of claim 2, wherein the secondary reflecting mirror is formed as a concave mirror which has upper and lower edges protruding more than a central portion and is curved about the axis in the direction horizontal to the ground so that natural diffusion of the reflected sunlight in the up-down direction is offset.

7. The natural lighting device of claim 6, wherein the spacer is formed at the upper edge and the lower edge of the secondary reflecting mirror between the support plate and the secondary reflecting mirror and has a direction parallel to the ground as a longitudinal direction and supports the upper and lower edges of the secondary reflecting mirror so that the upper and lower edges protrude more than the central portion.

8. The natural lighting device of claim 7, wherein a radius of curvature of the concave mirror is 100 m or more and 130 m or less.

9. The natural lighting device of claim 6, further comprising a tertiary reflector configured to reflect secondarily reflected sunlight, which is reflected from the secondary reflector, incident thereon toward the shaded area.

10. The natural lighting device of claim 9, wherein the tertiary reflector is installed beside the secondary reflector while being spaced apart from the secondary reflector.

11. The natural lighting device of claim 9, wherein the tertiary reflector includes a tertiary reflecting mirror which is curved about the axis in the direction intersecting with the ground so that natural diffusion of the reflected sunlight in the left-right direction is offset.
